(19) United States
(12) Patent Application Publication
(10) Pub. No.: US 2011/0199343 A1
(43) Pub. Date: Aug. 18, 2011

(54) METHOD FOR GENERATING AND AUTOMATICALLY SENDING A HANDWRITTEN ELECTRONIC MESSAGE

(76) Inventor: Jacques Cinqualbre, Rosheim (FR)

(21) Appl. No.: 12/733,115

(22) PCT Filed: Jul. 30, 2008
(86) PCT No.: PCT/FR2008/001140

§ 371 Date: Mar. 18, 2010

(30) Foreign Application Priority Data
Aug. 9, 2007 (FR) 0705799

(51) Int. Cl. G06F 3/033

(52) U.S. Cl. 345/179

(57) ABSTRACT

A method for generating and automatically sending an electronic message handwritten on a writing substrate to a manually designated addressee, wherein the user takes the writing instrument from its storage holder, uses it to handwrite the message in a writing zone of the paper, manually selects before or after writing of the message, by means of the writing instrument, at least one box for identification of the addressee, the session ending with replacement of the writing instrument in its storage holder, which initiates the automatic sending process.

This invention is of interest to manufacturers of devices for communication on the basis of writing substrates.

### FIELD OF THE INVENTION

The invention relates to an intuitive and automatic method for writing, addressing and sending an electronic message (e-mail, but also fax, SMS text messages, etc.) without relying on the use of conventional IT acquisition peripherals, by means of a visual identification of the addressee and writing of the message by the manual, natural and common operation of writing with the aid of a pen on a paper or analogous writing substrate.

The invention also relates to the device comprising the means designed for employing the method according to the present invention.

### STATE OF THE ART

The procedure of writing and sending electronic messages remains complex and consequently poorly accessible to the non-initiated and to non-users of IT tools.

In a spirit of simplification, different methods have been set forth for simplifying the writing and the procedure for sending of electronic messages, based on writing on digital paper, but none achieves the significant simplification of the invention to be described hereinafter.

The first application of 3 Aug. 2001 by ANOTO invention Christer Faahreus et al., bearing publication number WO 0116691, relates to logic for organizing and transmitting data obtained by capturing a message written on digital paper. Activation icons are pre-printed on the digital paper sheet, initiating telephone dialing and a call, the sending of a fax or of electronic message. Nevertheless, in this case, as indicated in Example No. 1 of the description, electronic messages can be composed and sent in corresponding manner by activating electronic message icon 7c. Text messages may be sent as an alternative to the electronic messages. In both cases, the message content may be either converted to alphanumeric characters or sent in graphical form. Nevertheless, the complete address of the addressee must be written out in full in the character-recognition zone, in order that it can be mentioned in the message title, since this written address is subjected to character recognition in order to initiate sending of the message.

It is clearly understood that in this invention the icon corresponds to a function and not to the identification of the message addressee. Above all, as already indicated, the initiation of sending necessitates a specific and explicit operation of identification of the addressee by manually filling out boxes provided for this purpose in the document and then subjected to a writing recognition method.

This step is obligatory, and is not devoid of risks of sending failure or of error(s) with respect to the addressee.

Thus constraints remain for the user, as do uncertainties related to the performances of the software programs for recognition of writing, which influence effective dispatch of the message requiring a flawless composition.

In fact, the claims of that patent publication mentioning the term “electronic message” remain very general and do not describe the automation of the process.

Also known is PCT publication No. WO 02/39373, corresponding to an invention of Andreasson Markus, filed in the name of the ANOTO Company. It describes a different invention, which relates to a return coupon for ordering a product or requesting additional information, on the basis of an insert printed specifically for this purpose on digital paper in a newspaper or a magazine as indicated, for example, in the description of that patent. Assuming that the reader has an appropriate digital pen of the Bluetooth protocol type, it is understood that the integral transmission of the address of the reader of the newspaper containing the advertisement can be processed by the IT system of the newspaper, to be printed as is on an envelope or a label, so that it can subsequently be sent by the conventional postal channels. In this case also, although the digital paper and the sending of electronic messages are associated, the invention disclosed in the description of that patent publication proves to be completely different from the present invention.

These two inventions corresponding to two filings in the name of the ANOTO Company are based on the principle of electronic message in tandem with digital paper, but they do not meet the dual objective of the present invention, which is on the one hand to spare the user from acquiring the address of the addressee in writing and on the other hand complete automation of the procedure of sending the electronic message.

Thus the described method introduces a major simplification by permitting persons who are completely resistant to the use of a computer and its peripherals (which serve as “man-machine” interface, keyboard, mouse, touch screen, etc.) or are incapable of operating it correctly, to send an electronic message to a designated addressee in the simplest possible manner.

### BRIEF DESCRIPTION OF THE INVENTION

The method is based on designating the addressee represented by a figurative graphical or alphanumeric element.

The message will be handwritten with the aid of a writing instrument on paper in a writing zone provided specifically for this purpose, and this will be done before or after the addressee is designated.

Regardless of the sequence, replacement of the writing instrument in its holder initiates a series of orders, culminating with the sending of the electronic message.

In the case of a link to a cellular phone of the GPRS or 3G type, linked to the digital pen by a protocol of the Bluetooth or similar type, contact will be established with a dedicated sending box on the paper sheet, if necessary protected by an intermediate flat substrate, which contact will initiate sending of the electronic message.

The main advantages of this method are those already mentioned, specifically the extreme simplicity for the user, its highly practical character and the attractive cost for the service rendered.

### LIST OF FIGURES

The present method will be readily understood by reading the description hereinafter, provided by way of non-limitative example in reference to the attached drawing, wherein:

FIG. 1 is a schematic view showing the writing sheet with a column of icons showing, by way of example, different possible addressees,

FIG. 2 is the general diagram of the architecture of the system for sending an electronic message according to the method according to the invention,

FIG. 3 is a flow diagram of successions of instructions concerning the sequence, from the user's viewpoint, of sending an electronic message, two alternatives being shown in this same figure,

FIG. 4 is a flow diagram of successions of phases illustrating the method of sending an electronic message.

### DETAILED DESCRIPTION OF THE INVENTION

The general objective of the invention is to be able to communicate via simple, common means, by preselecting the players potentially in the greatest demand, because they are the most useful or the closest.

In a different context, it may be imagined that this device is applicable within a business having recurrent and customary exchanges between physical persons or between departments within a chain of actions or services.

It may also be imagined that, with the aid of a notebook or notepad and of the combination of digital pen and mobile phone with the Bluetooth communication protocol or with any other communication protocol, the device of the invention can be made completely portable. Each page of the notepad or notebook may be a writing zone. One or more faces of the cover is or are each a zone for designating the addressee or addressees.

There now will be described the method of writing and sending an electronic message at the same time as the device according to the present invention with reference to the different figures.

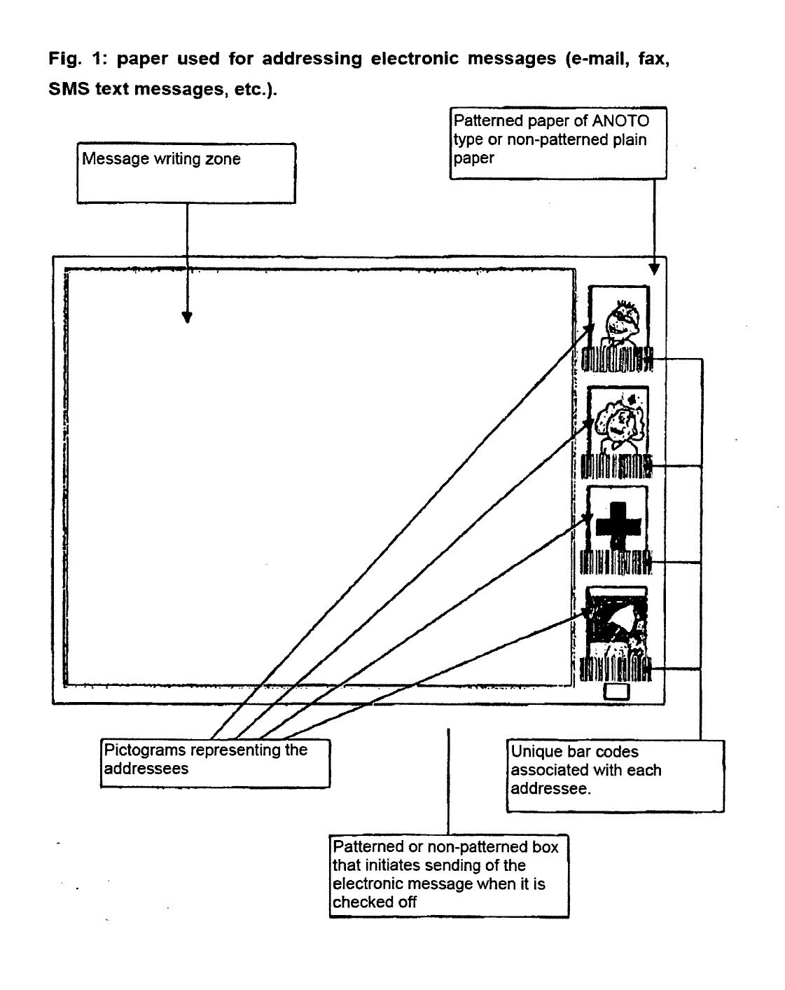

### DESCRIPTION OF FIG. 1

The description hereinafter will be based on conventional plain paper or on patterned paper, known as digital paper, such as exists in commerce. The paper may have the form of an isolated sheet or sheets, of a conventional notebook or notepad, or of a pad held together by a spiral or retained by a clip.

On the writing substrate available to the user, there will be two distinct zones: one for writing known as “writing zone” and the other for tracking, identifying and designating the addressee, known as “addressee designation zone”. There may also be a substrate for each function, specifically a substrate for the writing zone and another substrate for designating the addressee(s).

In the case of patterned paper, the message is written at a specific location and will be recognized and sent as such or after having been subjected to a method for recognition of the writing and designation of the addressee. In the case of plain paper, the writing may be done everywhere except in the zone for identifying the addressee. However, a visible location, defined by limits, is desirable.

The procedure of addressing the message to its addressee is based on visual recognition of graphical representations in the destination zone of the addressee by a succession of individual locations, such as specific boxes, each for one addressee and a particular manner of representing him graphically: pictograms, or alphanumeric messages, or graphical codes, such as bar codes, or any other precise and unequivocal sign, or combination thereof.

The term addressee will be used in the singular, but this is not to be construed as limiting sending to a single addressee.

For physical persons, it may involve photos, drawings or pathognomonic inscriptions (name, first name, last name, etc.). The heading may be based on the specialty of the professional designated generically and/or by his name, his photo, his professional logo. The same applies for a business (retailer, mini-market, supermarket), for a service (bank, insurance, security, emergencies) and others.

In all cases (patterned paper and plain paper), the chosen box representing the addressee in the zone for designating the addressee activates the action of recognizing and selecting him, the box being physically designated, pointed to or traveled over by the writing instrument or otherwise in momentary contact therewith or designated remotely.

A possible variant for selection of the addressee for the electronic message may be, in the case of use of a pen having the abilities to read and interpret bar codes, to travel over this code or these codes with the writing instrument. In this case, a different bar code for each possible addressee is printed over or next to each pictogram representing an addressee. Particular attention is given to the graphical location of the bar code and the pictogram associated therewith.

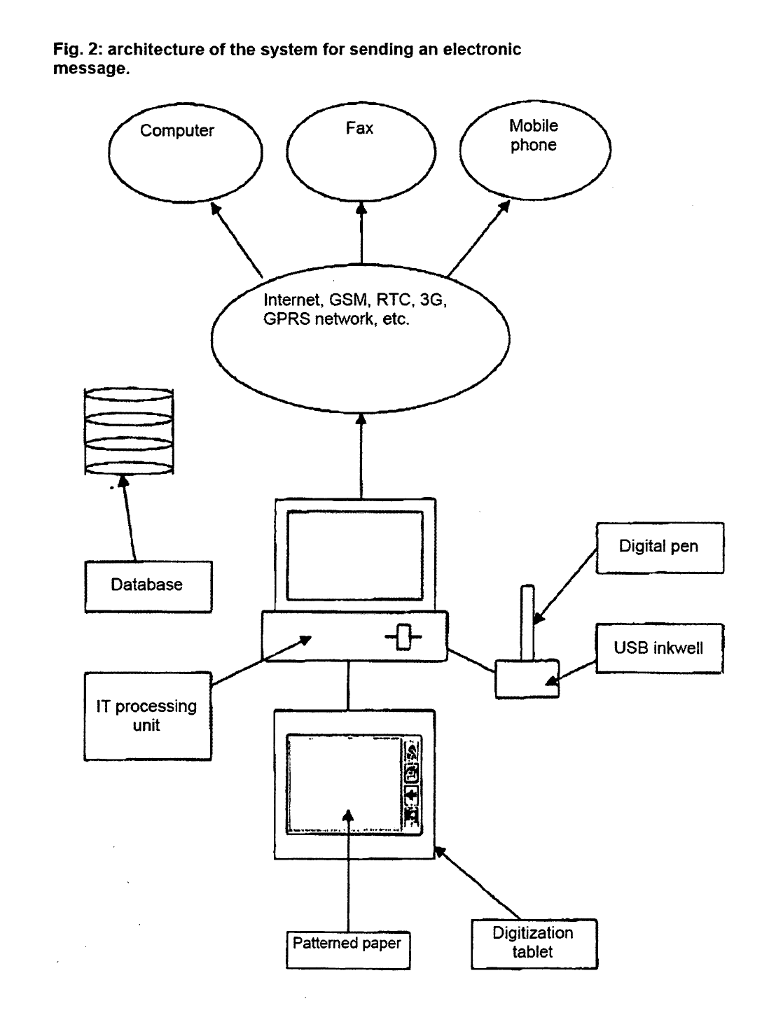

### DESCRIPTION OF FIG. 2

FIG. 2 is the general diagram of the architecture of the system for sending an electronic message according to the method according to the invention.

It comprises a sheet of patterned paper known as digital paper or a sheet of simple paper known as plain paper positioned on a digitization tablet.

It also comprises a digital pen having the abilities to write on a conventional paper sheet.

This digital pen may possess at least one or more electronic system(s):
permitting it to interpret the pattern printed on the paper in order to know its x and y coordinates relative to the sheet of patterned paper,
permitting it to read bar codes,
permitting it to transmit its position in x and y to the digitization tablet positioned underneath the paper sheet (in the case of employment of this invention with plain paper, or in other words non-patterned paper).

On the other hand, the digital pen may be additionally equipped with a system for transmitting data between it and the IT processing unit, which may be:
a USB-equipped storage medium. (USB inkwell) or
a wireless communication protocol of Bluetooth type.

In the case of employment of the method of the invention with a digitization tablet, it is the digitization tablet that sends the x and y position coordinates of the pen via a connection of USB type to the IT processing unit.

The system comprises the IT processing unit, which may be a computer of PC or Mac type functioning under any operating system (Windows, OSX, Linux, etc.), or a mobile phone having the abilities to execute IT programs, or any other system that can host the programs necessary for employment of this invention.

The system also comprises a database, which associates an addressee address (e-mail address, fax number, SMS number) with a zone defined by the coordinates thereof (x beginning, y beginning) (x end, y end) represented by a pictogram on the sheet of the user.

In the case of the use of bar codes to select the addressee, the database may associate an addressee address (e-mail address, fax number, SMS number, etc.) with a unique bar code.

This database may be installed locally on the IT processing unit, or else remotely on a server.

The system also comprises a data-transmission network (Internet, GSM, 3G, RTC, WiFi, etc.) to which the IT processing unit is connected in order to transmit the electronic message to its addressee, concerning whom one of the elements belonging thereto or to which he has access (computer, fax, mobile phone, etc.), such is also connected.

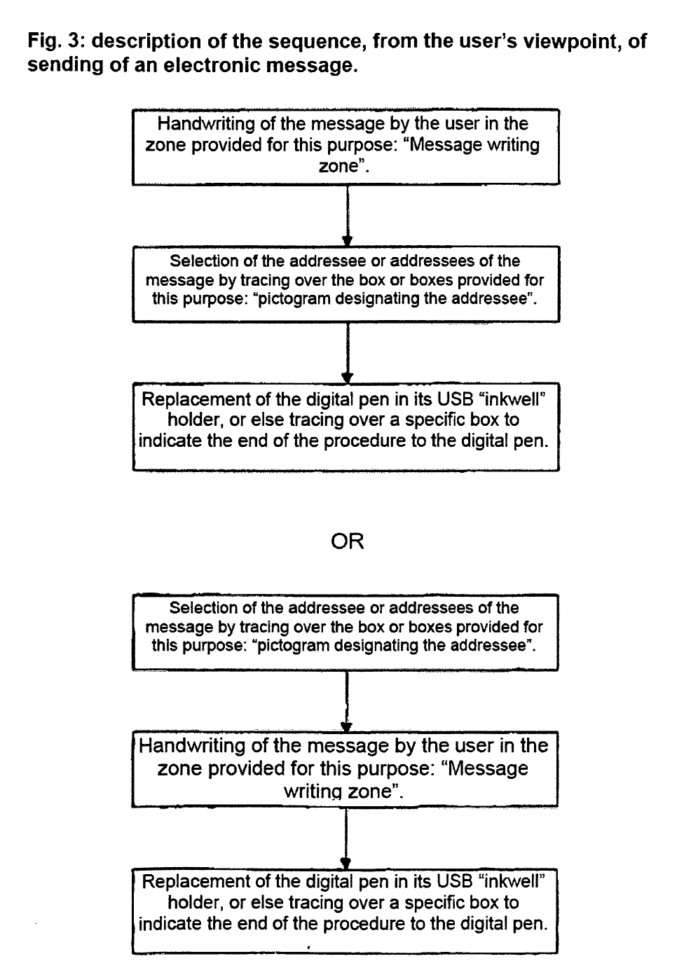

### DESCRIPTION OF FIG. 3

FIG. 3 is a flow diagram of successions of instructions concerning the sequence, from the user's viewpoint, of sending an electronic message, according to two variants.

In the case of digital paper and of plain paper positioned on a digitization tablet, the procedure will be described from the users viewpoint and then by detailing the succession of internal operations.

Thus the present method provides a significant simplification by permitting persons who are resistant to the use of the computer and its peripherals, which serve as “man-machine” interface, keyboard, mouse, touch screen, etc., or who are incapable of operating it correctly, to send an electronic message in the simplest possible manner to an addressee designated figuratively after the message has been written on the paper by means of a writing instrument of pen type.

It is based on visual identification of a pictogram or of a figurative objective illustration of the addressee by photo, drawing, symbol or any other means. It also may involve, for example, an evocative logo (red cross for a pharmacy, logo with corporate name or a combination evocative of the addressee by alphanumeric combination), or even the name—or first name/last name—of the person or entity in question.

The next step will be to designate the addressee by pointing to or checking off or by another gesture with direct contact or via a flat opaque or, for example, transparent protective substrate, or by remote contact, the box in which the designated addressee appears by name or is represented in evocative manner. A possible variant for selection of the addressee of the electronic message may be, in the case of use of a pen having the abilities to read and interpret bar codes, to pass the writing instrument over this pen obviously associated with the pictogram under consideration.

Then, or before designation of the addressee or addressees, the message will be handwritten with the aid of the same writing instrument, having dual mechanical and digital functions, thus preferably leaving a visible written trace on the paper.

In the case of patterned paper, replacement of the digital writing instrument in its storage holder, such as a USB inkwell, initiates a series of orders, culminating in the sending of the electronic message (FIG. 1).

In the case of patterned paper and in the case of use of a digital pen having the abilities to transmit data by a wireless communication protocol of the Bluetooth or similar type, a dedicated patterned box will be checked off on the paper sheet, the contour of which box preferably will be graphically visible to the user, who will initiate sending of the electronic message (FIG. 1).

The same procedure will be followed in the case of use with a plain paper positioned on a digitization tablet, in order to initiate sending of the electronic message by checking off a dedicated non-patterned box, the contour of which preferably will be graphically visible to the user (FIG. 1).

The advent of new-generation touch screens allowing several simultaneous manipulations gives an insight into the possibilities of automatic addressing by selecting, dragging and dropping diverse messages.

Nevertheless, the correspondence medium most used for transmission of non-verbal messages continues to be the paper substrate with handwriting.

As already indicated, the general objective of the invention is to permit any individual in simple, natural and quasi-intuitive manner to transmit an electronic message by using merely his ability to observe familiar images and his skill in writing a manuscript message on a sheet of paper, with the double effect of avoiding explicit acquisition of the address of the addressee and of completely automating the procedure of sending of the message.

If the sending device is provided with a monitor screen, a message can be displayed thereon, such as:

“Your message has been sent to XXX.”

Similarly, a response will be announced by a message on this same screen, of the type:

“XXX has replied to you. Click here to read the message or there to listen to it”

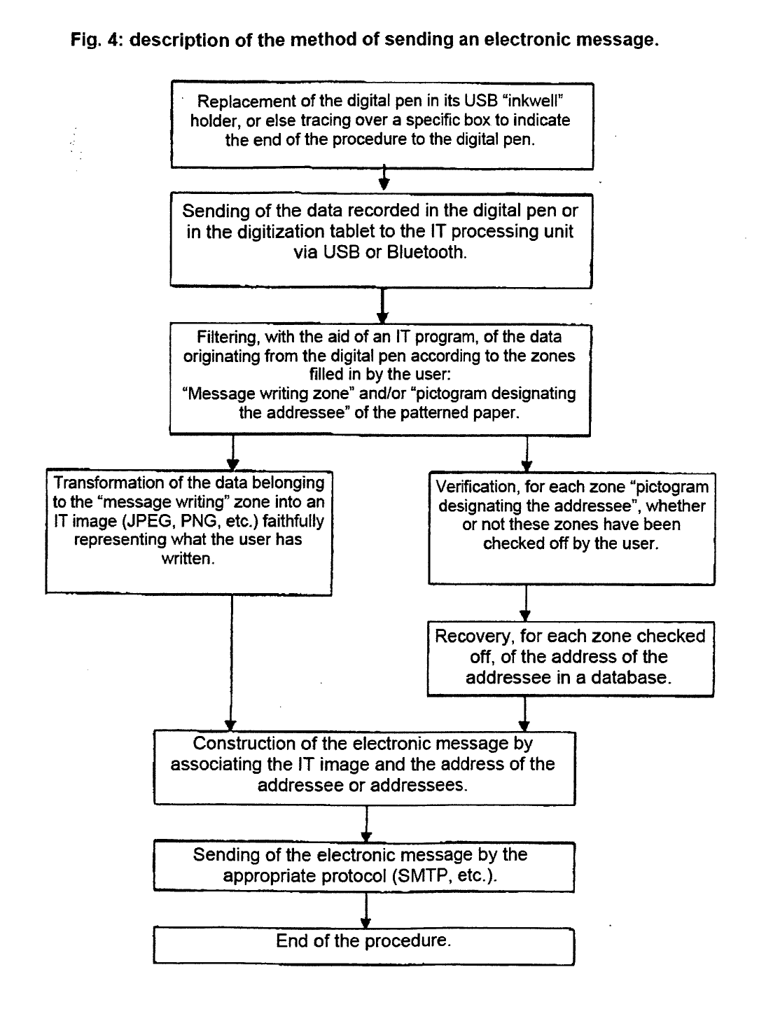

### DESCRIPTION OF FIG. 4

The chain of internal operations will now be described with reference to FIG. 4.

First of all the chain of internal operations will be described in the case of employment of this invention with digital pens manufactured, for example, by the companies LOGITECH, NOKIA, MAXELL, etc.

It is important to state that the pattern used, composed of a multitude of points printed according to a mathematical algorithm, permits the digital pen (capable of interpreting this pattern) to know and record its position (x, y) relative to the sheet of patterned paper.

When the digital pen receives the order to send its data to the IT processing unit (replacement of the digital pen in the storage holder, such as a USB inkwell, or direct or remote contact with a specific patterned box so as to issue the order to the pen to send its data by Bluetooth wireless communication protocol), it transmits:
the unique identifying number of the digital pen used,
the number of different patterned pages on which the digital pen has written,
the starting date, relative to its internal clock, on which it wrote its first line.
   During this same time, for each page on which the digital pen has written, it transmits:
the address of the pattern or the identifier of the pattern,
the area of the pattern, by giving the coordinates thereof (x min, y min) and (x max, y max),
the number of lines present on the patterned page in question (one line=everything that the pen writes between the moment at which the user applies the tip to the paper and the moment at which he lifts the tip from the paper).
   Simultaneously, for each line created by the digital pen, it transmits:
the line thickness (function of the pressure applied by the user on the pen),
the line color (blue or black by default),
the coordinates of all of the points captured by the digital pen in the course of the line (during writing, the pen captures its position coordinates. Technically, it may capture up to 50 points per second).
   This is followed by the phase of data filtering.
   This is accomplished relative to a reference IT file (PAD file), which describes the different zones of the patterned paper in virtual manner. Within the scope of this patent, several zones are characterized by their respective coordinates (x beginning, y beginning) (x end, y end):
the zone in which the manuscript message is written: “message writing zone”,
the zones associated with the pictograms: “zone for designation of the addressee or addressees”.
   In this context, a software program will filter the lines by grouping, on the one hand, all the lines for which the coordinates of the points composing them belong to the “message writing zone” and by grouping, on the other hand, all the lines for which the coordinates of the points composing them belong to the zone or zones associated with the pictograms—“zone for designation of the addressee or addressees”.
   Subsequently, software processing will be applied according to the category of the lines:
all lines belonging to the “message writing zone” will be reproduced faithfully by means of a software program as an IT image of JPEG, PNG or other type.
all lines belonging to the zone or zones associated with the pictograms will simply determine, by a logic test, to which addressee or addressees this message must be sent.
   In the context of addressing the manuscript message, there exists a database that associates an addressee address (e-mail address, fax number, SMS number) with a zone defined by its coordinates (x beginning, y beginning) (x end, y end) represented by a pictogram on the user's sheet. Finally, once all these operations have ended, an IT program assembles the content (IT image of JPEG, PNG or other type, representing the manuscript message) and the address of the designated addressee, then sends it over the network (Internet, GPRS, 3G, etc.) with the appropriate protocol (SMTP, etc.) corresponding to the receiving terminal of the addressee (computer, fax, telephone, etc.).

### Variants In The Chain Of Internal Operations Described In The Foregoing

Several variants can be introduced into the chain of internal operations described in the foregoing.
The first variant in the chain of internal operations relates to increasing the level of security for sending the message. This can be employed in the chain of internal operations described in the foregoing but also in the variants described hereinafter.
It is possible to add a supplementary operation, wherein the writing instrument, such as the digital pen, does not discharge its memory immediately after it has been replaced in its storage holder, known as an inkwell, but instead this operation initiates a preliminary interrogation in order to verify the pertinence of the designation of the addressee. If this operation is validated, the sending process will continue as in the foregoing.
The second variant in the chain of internal operations concerns the use of a non-patterned plain paper sheet positioned on a digitization tablet together with a pen equipped with an electronic or electromagnetic system permitting it to transmit its position in x and y to the digitization tablet. This is then composed of, among other elements, a matrix of microsensors capable of knowing and recording the position (x, y) of the tip of the writing instrument by the use of diverse physical phenomena and quantities, whose variations are transmitted by the microsensors to the processing unit. It may concern either an electromagnetic signal emitted by the electronic or electromagnetic system, associated physically with the writing instrument, or the detection of the pressure applied by the tip on the writing substrate, Other possibilities such as electro-optical sensors, CCD diode networks, etc. may also be cited.
This second variant may be employed in the chain of internal operations and all variants described in the foregoing but also in the variants described hereinafter.
In this case, it is the digitization tablet placed under the plain paper sheet that sends, to the IT processing unit, all the coordinates (x, y) of all the lines made by the User. The sending of these x, y coordinates is achieved by checking off a dedicated box, whose contour preferably will be graphically visible to the user.
Thereafter the process of sending the electronic message is identical to the case of patterned paper.
The third variant in the chain of internal operations concerns the use of a digital pen having the abilities to read bar codes. This can be employed in the chain of internal operations and all the variants described hereinabove.
In this context, there is no logic test to determine to which addressee or addressees the electronic message must be sent on the lines belonging to the zones (x beginning, y beginning) (x end, y end) associated with the pictograms.
Consequently, this operation is replaced by a comparison between the unique bar code or codes read by the digital pen and sent to the IT processing unit and the unique bar code or codes referenced in the database and associated with an addressee address (e-mail address, fax number, SMS number, etc.).

1-30. (canceled)

31. A method for generating and sending a handwritten electronic message to an addressee, characterized in that the message is handwritten on a writing substrate with the aid of a writing instrument in a writing zone, in that the acquisition of the message takes place on a writing substrate permitting tracking of the position of the tip of the writing instrument, in that this same addressee is selected before of after the message is written by manual designation with the aid of the writing instrument toward or on a substrate having a zone for designating the addressee, which zone is formed by locations specific to each addressee and can be visually tracked by the user, and in that the sending operations are initiated by placing the writing instrument in its storage holder.

32. A method for generating and sending a handwritten electronic message to an addressee according to claim 31, characterized in that the user takes the writing instrument from its storage holder, handwrites the message in a writing zone of the writing substrate in association with tracking of the writing end of the writing instrument, in that the user, by an action toward or in a given location specific to the addressee and situated in a zone for designating the addressee, which zone is formed by a plurality of individualized locations or boxes provided in each case with at least one graphical element representing the addressee directly or by a symbol or schematically, manually designates the addressee before or after having written the electronic message, and in that the user ends his session and initiates the automatic sending sequence when he replaces the writing instrument in its storage holder.

33. A method according to claim 31, characterized in that designation takes place by selection of at least one box by contact between the writing instrument and the writing substrate.

34. A method according to claim 31, characterized in that the user writes the electronic message on a flat protector covering the writing substrate.

35. A method according to claim 31, characterized in that the writing substrate is a paper.

36. A method according to claim 35, characterized in that the writing substrate is a patterned paper.

37. A method according to claim 35, characterized in that the writing substrate is a plain paper.

38. A method according to claim 31, characterized in that the writing instrument is a digital pen.

39. A method according to claim 38, characterized in that the digital pen is provided with a graphical code reader.

40. A method according to claim 31, characterized in that the contact of the writing end of the digital pen on the writing substrate activates the message-capture process.

41. A method according to claim 31, characterized in that the data belonging to the writing zone of the message are transformed into an IT image.

42. A method according to claim 31, characterized in that an electronic message is formed by associating the IT image and the address of the addressee or addressees.

43. A method according to claim 31, characterized in that the sending process is initiated and in that the electronic message is sent by an appropriate protocol after replacement of the IT pen in its storage holder.

44. A method according to claim 31, characterized in that tracking of the end of the writing instrument in contact with the plain paper takes place in a writing tablet by a method of tracking in X, Y coordinates.

45. A method according to claim 44, characterized in that the tracking uses a matrix of microsensors.

46. A method according to claim 31, characterized by a supplementary operation, wherein the writing instrument does not discharge its memory immediately after it has been replaced in its storage holder, but instead this operation initiates a preliminary interrogation in order to verify the pertinence of the designation of the addressee, the sending process continuing as in the foregoing if this operation is validated.

47. A method according to claim 31, characterized in that the physical element identifying the addressee may be a bar code adjacent to the box or included therein, which bar code will be passed over by the writing instrument before or after the message is written.

48. A method according to claim 36, characterized in that the patterned paper has the form of an isolated sheet or sheets, of a conventional notebook or notepad, or of a pad held together by a spiral or retained by a clip, the substrate connected to a transmission tool or to a computer supporting the digital paper technology or to an interactive terminal containing the core of a PC with expressive potential restricted so as to facilitate and/or channel its use in dedicated specific tasks.

49. A device for generating and sending a handwritten electronic message to an addressee, comprising:
a writing substrate for plain paper or patterned paper, wherein said writing substrate has a writing zone and an addressee zone;
a writing instrument having a tip for composing a handwritten message upon said writing zone of said writing substrate, wherein the position of said tip of said writing instrument up-on said writing substrate can be tracked, and wherein a specific addressee, to which said handwrit-ten electronic message is to be sent can be selected by said tip of said writing instrument contact-ing a specific addressee located within said addressee zone; and
a storage holder for housing said writing implement upon completion of the gene-ration of said handwritten electronic message whereupon transmission instructions will be initiated.

50. A device according to claim 49, characterized in that the writing substrate is a notepad, each page of said notepad being a writing zone and the zone for designating the addressee or addressees being at least one of the cover faces of the notepad.

51. A system for generating and sending a handwritten electronic message to an addressee, comprising:
at least one sheet of patterned or non-patterned paper;
a digital writing instrument equipped with an electronic system capable of reading and interpreting the patterns of the patterned paper and being capable of being equipped with an electronic system for data transmission by a wireless protocol of the Bluetooth type;
a storage holder of the USB inkwell type;
an IT processing unit;
a database;
IT programs;
a data transmission network of the Internet, GPRS, WIFI, RTC, 3G, or other type; and
at least one component for receiving electronic messages, such as, for example, a fax, computer, mobile phone, or the like.

52. A system according to claim 51, characterized in that it comprises at least one sheet of plain paper, a digitization tablet having USB or similar connections, said writing instrument being equipped with a tracking system for said digitization tablet.

53. A system according to claim 51, characterized in that it comprises at least one sheet of patterned paper or non-patterned plain paper, a writing instrument equipped with an electronic system capable of reading bar codes and equipped with an electronic system capable of reading and interpreting the patterns of the patterned paper.
